(19) United States
(12) Patent Application Publication
(10) Pub. No.: US 2022/0271708 A1
(43) Pub. Date: Aug. 25, 2022

(54) ROTARY APPARATUS AND CLEANING METHOD

(71) Applicant: SONY GROUP CORPORATION, Tokyo (JP)

(72) Inventor: KEIICHI HIRANO, TOKYO (JP)

(21) Appl. No.: 17/630,294

(22) PCT Filed: Jun. 2, 2020
(86) PCT No.: PCT/JP2020/021761

§ 371 Date: Jan. 26, 2022

(30) Foreign Application Priority Data
Aug. 8, 2019 (JP) 2019-145937

(51) Int. Cl. H02S 40/10; A01K 13/00; B08B 1/00

(52) U.S. Cl. CPC H02S 40/10; A01K 13/00; B08B 1/00

(57) ABSTRACT

Provided is a rotary apparatus (1) which includes: a rotary part (4) which rotates by being imparted an external force; a rotation regulating part (3) which regulates rotation of the rotary part (4) in one direction; and an attaching part (2) which allows the rotary part (4) to be attached in a state of being contactable with a contact part, and by sliding the rotary part (4) and the contact part with each other, a light receiving part (P) which receives light for a solar battery panel is cleaned.

### TECHNICAL FIELD

The present disclosure relates to a rotary apparatus and a cleaning method.

### BACKGROUND ART

A solar battery panel has a problem in that when a certain period of time has elapsed after installation thereof, dust and dirt are accumulated and a power generation efficiency is reduced. Therefore, for example, the below-mentioned Patent Document 1 discloses a technology of automatically cleaning a daylighting surface of the solar battery panel without intervention of manpower. In this technology disclosed in Patent Document 1, since in a case where a power generation efficiency is reduced to be lower than an allowable value, automatic cleaning is performed by a cleaning mechanism, power consumption required for the cleaning can be suppressed.

### CITATION LIST

### Patent Document

Patent Document 1: Japanese Patent Application Laid-Open No. 10-136864

### SUMMARY OF THE INVENTION

### Problems to be Solved by the Invention

However, the cleaning mechanism disclosed in Patent Document 1 operates by supplying power to a motor and has a problem in that the power is consumed upon cleaning. Therefore, a technology which favorably maintains a daylighting state of the solar battery panel without using the power is demanded.

Accordingly, one of objects of the present disclosure is to provide a rotary apparatus and a cleaning method, each of which allows a daylighting state of a solar battery panel to be favorably maintained without requiring energy costs.

### Solutions to Problems

The present disclosure is a rotary apparatus which includes:

a rotary part which rotates by being imparted an external force;

a rotation regulating part which regulates rotation of the rotary part in one direction; and

an attaching part which allows the rotary part to be attached in a state of being contactable with a contact part, and

by sliding the rotary part and the contact part with each other, a light receiving part which receives light for a solar battery panel is cleaned.

In addition, the present disclosure is a cleaning method which includes:

attaching a rotary part which rotates by being imparted an external force in a state of being contactable with a contact part; regulating rotation of the rotary part in one direction by a rotation regulating part; and cleaning a light receiving part which receives light for a solar battery panel by sliding the rotary part and the contact part with each other.

### BRIEF DESCRIPTION OF DRAWINGS

FIG. 1 is an external view illustrating a configuration example of a rotary apparatus according to a first embodiment.

FIG. 2 shows a front view, a right side view, a plan view, and a bottom view illustrating the configuration example of the rotary apparatus according to the first embodiment.

FIG. 3 shows schematic views illustrating other configuration examples of a rotary part.

FIG. 4 is an explanatory diagram for explaining a mechanism of cleaning by the rotary apparatus.

FIG. 5 is a block diagram showing a configuration example of an IoA apparatus to which the rotary apparatus can be applied.

FIG. 6 is an explanatory diagram for explaining an operation example of the IoA apparatus.

FIG. 7 shows views illustrating a configuration example of a rotary apparatus according to a second embodiment.

FIG. 8 is a diagram illustrating a configuration example of a rotary apparatus according to a third embodiment.

FIG. 9 is a diagram illustrating a configuration example of a rotary apparatus according to a fourth embodiment.

FIG. 10 is a diagram illustrating another configuration example of the rotary apparatus according to the fourth embodiment.

FIG. 11 is a diagram illustrating another configuration example of the rotary apparatus according to the fourth embodiment.

FIG. 12 is a diagram illustrating a configuration example of a rotary apparatus according to a fifth embodiment.

FIG. 13 is a diagram illustrating a configuration example of a rotary apparatus according to a sixth embodiment.

FIG. 14 is a diagram illustrating a configuration example of a rotary apparatus according to a seventh embodiment.

### MODE FOR CARRYING OUT THE INVENTION

Hereinafter, embodiments of the present disclosure will be described with reference to the accompanying drawings. The present technology will be described in the following order. Note that in the present description and the drawings, the same or corresponding components are denoted by the same reference signs, and overlapping description will be omitted.

<1. First Embodiment>

<2. Second Embodiment>

<3. Third Embodiment>

<4. Fourth Embodiment>

<5. Fifth Embodiment>

<6. Sixth Embodiment>

<7. Seventh Embodiment>

<8. Modified Example>

### 1. First Embodiment

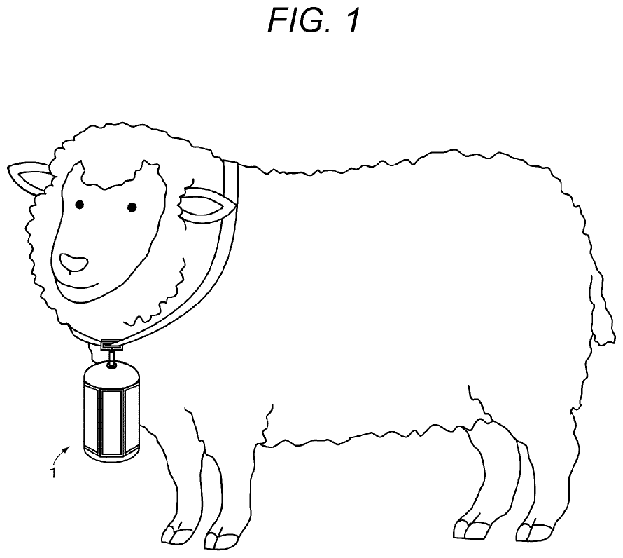

FIG. 1 is an external view illustrating a configuration example of a rotary apparatus according to a first embodiment. The rotary apparatus 1 illustrated in FIG. 1 is a rotary apparatus which is applied to a wearable apparatus worn by a sheep. In other words, an attaching target of the rotary apparatus 1 is the sheep. Note that the attaching target is not limited to the sheep, and the attaching target may be another animal, such as a cattle and a goat, which is pastured or may be a bird, such as a chicken and an ostrich, which is free-range. In addition, the attaching target is not limited to the above-mentioned live stocks and may be a pet such as a dog and a cat. For example, as illustrated in FIG. 1, this rotary apparatus 1 is used such that a collar or the like is used and the rotary apparatus 1 is suspended from a neck. The attachment place for the rotary apparatus 1 is not limited to the neck and may be another place such as an ear, a leg, a belly, buttocks, and a tail. Note that although in FIG. 1, in order to facilitate the description, the rotary apparatus 1 is drawn in a large size, as compared with a physical size of the sheep, in reality, the rotary apparatus 1 is configured to have a size with which the sheep wearing the rotary apparatus 1 does not receive any stress.

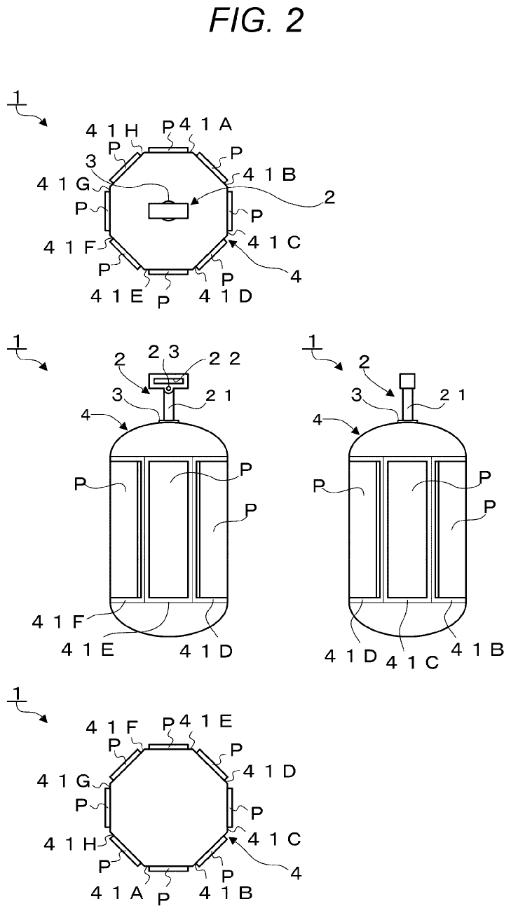

FIG. 2 shows a front view, a right side view, a plan view, and a bottom view illustrating the configuration example of the rotary apparatus 1 according to the first embodiment. Note that a rear view is similar to the front view and a left side view is similar to the right side view and herein, illustration of the rear view and the left side view is omitted. As illustrated in FIG. 2, the rotary apparatus 1 has an attaching part 2 as an attaching portion, a rotation regulating part 3, and a rotary part 4.

The attaching part 2 has a structure for mounting (attaching) the rotary apparatus 1 to the sheep as the attaching target and is configured to allow the rotary part 4 to be attached to a body of the sheep as one example of a contact part in a state of being contactable with the body thereof. Note that the contactable state is a state in which the rotary part 4 contacts the contact part by applying an external force such as the later-described motion of the sheep and in a state in which the external force is not applied (in a state in which the rotary apparatus 1 is in a still state), the rotary part 4 may contact the contact part or may not contact the contact part. For example, this attaching part 2 is configured by using a material having high durability, such as metal. Specifically, the attaching part 2 has a hole 22, on one end side of a rod-like shaft part 21, through which the collar (a belt) can be inserted. A member in which the hole 22 is formed and the shaft part 21 are mutually pivotally supported by a movable part 23 such as a pin, and the rotary part 4 is configured to be swingable as a whole with the movable part 23 as an axis. Note that a shape, a position, and the like of the attaching part 2 may be a shape, a position, and the like thereof other than those illustrated as long as the shape, the position, and the like thereof have similar functions.

The rotation regulating part 3 has a function to regulate a rotational direction in one direction. For example, as with the attaching part 2, this rotation regulating part 3 is configured by using a material having high durability, such as metal. Specifically, the rotation regulating part 3 is configured by a circular-ring-shaped one-way clutch and is attached on one end side of the shaft part 21 by inserting the shaft part 21 of the attaching part 2 therethrough. Note that the rotation regulating part 3 may be a rotation regulation part which regulates the rotational direction by using other mechanical structure such as a mechanism like a ratchet mechanism or a bicycle free wheel. Although the structure of the rotation regulating part 3 is not particularly limited, it is preferable that the rotation regulating part 3 has a structure which is strong against dust, dirt, and the like so as to be operable to withstand outdoor use.

The rotary part 4 is a member which is configured to be rotatable in one direction in a state in which the rotary apparatus 1 is attached to the sheep. For example, this rotary part 4 is configured by using a material such as resin, which is excellent in workability, is lightweight, and is comparatively stout. Specifically, the rotary part 4 has an octagonal prism-shaped external surface, the shaft part 21 of the attaching part 2 is located on a center line of a prismatic body thereof, and the rotary part 4 is attached to the shaft part 21 in such a way as to be rotatable with the shaft part 21 as a center. Note that between this rotary part 4 and the shaft part 21, the above-described rotation regulating part 3 is interposed and rotation of the rotary part 4 is regulated. Specifically, the rotational direction of the rotary part 4 is regulated in one direction (a clockwise direction or a counterclockwise direction with a central axis of the prismatic body as an axis) by the rotation regulating part 3.

The rotary part 4 has solar battery panels P on the external surface. These solar battery panels P are portable (having a small size which allows the sheep to carry). Specifically, on the rotary part 4, the solar battery panels P are attached to eight external surfaces (an external surface 41A to an external surface 41H) constituted of a side surface among octagonal prism-shaped external surfaces as illustrated, respectively. Note that the solar battery panels P are attached in a state in which daylighting surfaces are located on an external side. For example, the rotary apparatus 1 is configured to be operable to supply power obtained by the solar battery panels P to electric and electronic circuitry. Note that the solar battery panels P may be attached to one part of the eight external surfaces (for example, four solar battery panels P in total on each two surfaces), instead of all of the external surfaces.

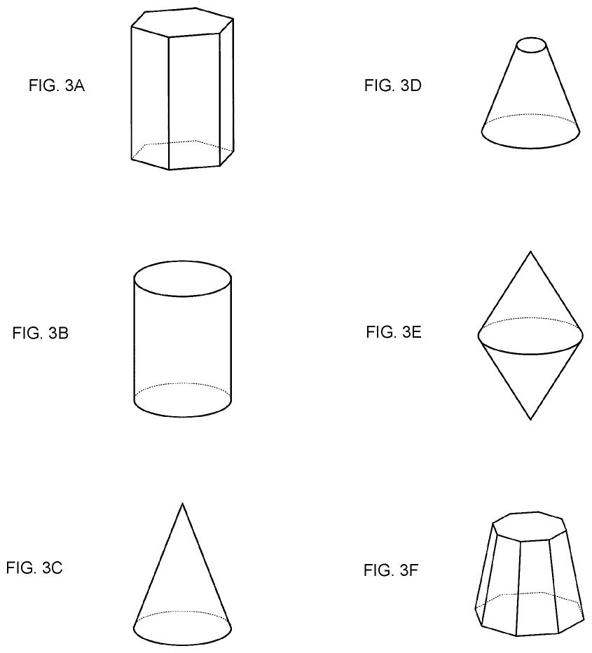

Incidentally, a shape of the rotary part 4 is not limited to the shape illustrated in FIGS. 1 and 2. FIG. 3 shows schematic views illustrating other configuration examples of the rotary part 4. For example, as illustrated in FIG. 3A, the rotary part 4 may be configured to be of a shape of a polygonal prism other than the octagonal prism or as illustrated in FIG. 3B, may be configured to be of a circular column shape. In addition, as illustrated in FIG. 3C, the rotary part 4 may be configured to be of circular cone shape or may be configured to be of a polygonal pyramid shape. Furthermore, as illustrated in FIG. 3D and FIG. 3E, the rotary part 4 may be configured to be of different shapes other than the above-mentioned shapes. In addition, as illustrated in FIG. 3F, the rotary part 4 may be of, for example, a trapezoidal frustum shape having eight side surfaces. The rotary part 4 is made to have the shape illustrated in FIG. 3F, thereby allowing solar light to be easily made incident on the solar battery panels P which are attached to the side surfaces, as compared with the other shapes (shapes illustrated in FIG. 3A and FIG. 3B). In addition, since the side surfaces are not curved surfaces but flat surfaces, solar battery panels P which cannot be bent can be applied. In addition, because the shape illustrated in FIG. 3F resembles a shape of a bell which is attached to a belt of the sheep in general, stress which is exerted on the sheep by attaching the rotary apparatus 1 to the sheep can be alleviated. For example, in a case where the rotary part 4 is attached to the rotary apparatus 1 as an attaching target, it is useful to remove edges and corners so as not to hurt the attaching target. In addition, it is also useful to take shapes of surfaces which increase a power generation efficiency of the solar battery panels P (for example, surfaces having fixed angles or surfaces having varying angles to attain a good power generation efficiency). In addition, the rotary part 4 may be of, for example, a shape having a space therein (for example, a box shape, a cylinder shape, or the like). Note that the shape of each of the solar battery panels P is not limited to the flat shape and may be a curved surface shape.

The rotary apparatus 1 have the above-described structure, thereby realizing a function to favorably maintain a daylighting state of the solar battery panels P. Specifically, the rotary apparatus 1 has a structure in which an external force obtained from motion of the sheep is converted to energy required for cleaning, and daylighting surfaces of the solar battery panels P are cleaned by the converted energy, thus, realizing effect of favorably maintaining the daylighting state.

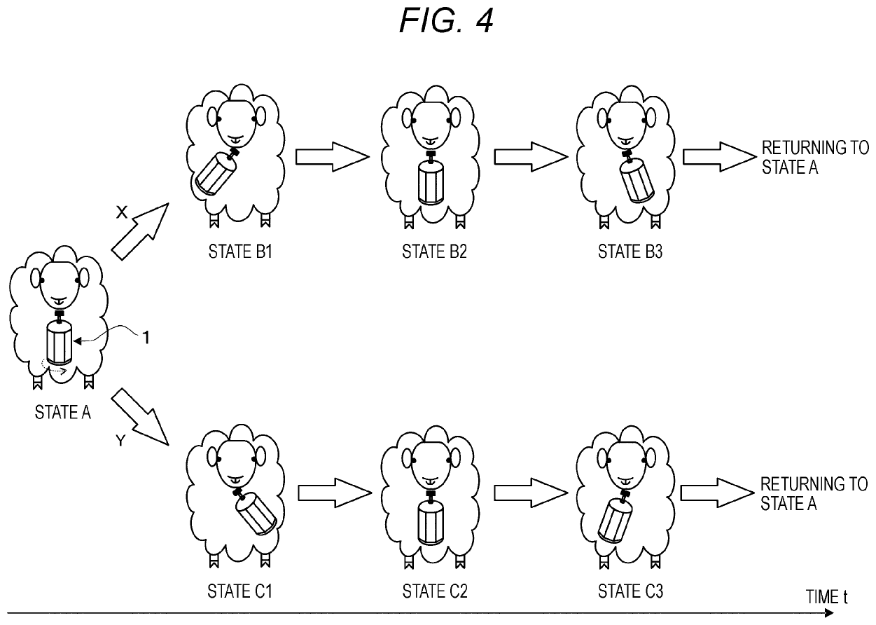

FIG. 4 is an explanatory diagram for explaining a mechanism of cleaning by the rotary apparatus 1. A state A is a state in which the sheep stands still. Note that the rotary apparatus 1 rotates only in a direction indicated by a dashed line arrow by the rotation regulating part 3. It is supposed that in this state, the external surface 41A (see FIG. 2) of the rotary part 4 of the rotary apparatus 1 contacts breast pelage of the sheep. A state B1 in a motion case X is a state in a case where the sheep moves its body in a left direction from a viewpoint of the sheep. When the sheep moves its body in the left direction from the viewpoint of the sheep, a force is exerted by inertia of the rotary apparatus 1 in a direction in which the rotary apparatus 1 inclines toward a right side from the viewpoint of the sheep. At this time, a frictional force is generated between the external surface 41A of the rotary apparatus 1 and the breast pelage of the sheep, the rotation of the rotary apparatus 1 (rotary part 4) is regulated by the rotation regulating part 3, and the external surface 41A of the rotary apparatus 1 is thereby cleaned by the frictional force.

Next, from the state B1 to a state B2, the inclined rotary apparatus 1 starts pendular motion by a gravity force. At this time, although the frictional force is generated again between the external surface 41A of the rotary apparatus 1 and the breast pelage of the sheep, here, the rotation of the rotary apparatus 1 is not regulated by the rotation regulating part 3, the rotary apparatus 1 rotates by the frictional force, and a surface on which the rotary apparatus 1 and the breast pelage of the sheep contact each other is changed from the external surface 41A to the external surface 41B or to another surface (determined depending on a degree of the rotation).

Furthermore, in a case where energy to continue the pendular motion is still left in the rotary apparatus 1, from the state B2 to a state B3, the pendular motion of the rotary apparatus 1 is continued, and the remaining energy is utilized to clean the rotary apparatus 1 or the rotation thereof.

A state C1 in a motion case Y is a state in a case where the sheep moves its body in a right direction with the viewpoint of the sheep, and although order of the rotation and cleaning of the rotary apparatus 1 is different, behavior in which by converting the energy obtained from the motion of the sheep alternately to rotation energy and cleaning energy, the surfaces of the rotary apparatus 1 are sequentially cleaned is the same as that in the above-described motion case X.

In each of the motion case X and the motion case Y, when the pendular motion is finished, the state returns to the still state in the state A. Thus, in accordance with the motion of the sheep, the daylighting surfaces of the solar battery panels P attached to the external surfaces of the rotary part 4 are cleaned. In other words, in a case where the rotary apparatus 1 is used, the body pelage of the sheep functions as a cleaning part for cleaning the solar battery panels P.

As described above, in the present embodiment, the body of the sheep as one example of the contact part has the body pelage as the cleaning part. In addition, the solar battery panels P are attached to the external surfaces of the rotary part 4 of the rotary apparatus 1. In other words, the rotary apparatus 1 has the above-described rotary part 4, rotation regulating part 3 which regulates the rotation of the rotary part 4, and attaching part 2 which can attach the rotary part 4 to the body of the sheep in a state of being contactable with the body of the sheep, and the rotary apparatus 1 has the structure in which the rotary part 4 and the body of the sheep contact each other and the solar battery panels P as a light receiving part which receives light for the solar battery panels and the body pelage of the sheep which cleans the solar battery panels P thereby contact each other. Therefore, the rotary part 4 and the body of the sheep (the body pelage of the sheep in the present embodiment) slide with each other (sliding in a contacting state) by the above-described motion of the sheep, and thus, the solar battery panels P attached to the external surfaces of the rotary part 4 are thereby cleaned and the daylighting state of the solar battery panels P is favorably maintained.

This rotary apparatus 1 can be applied to, for example, a maintenance-free sheep action sensing Internet of Animals (IoA) apparatus.

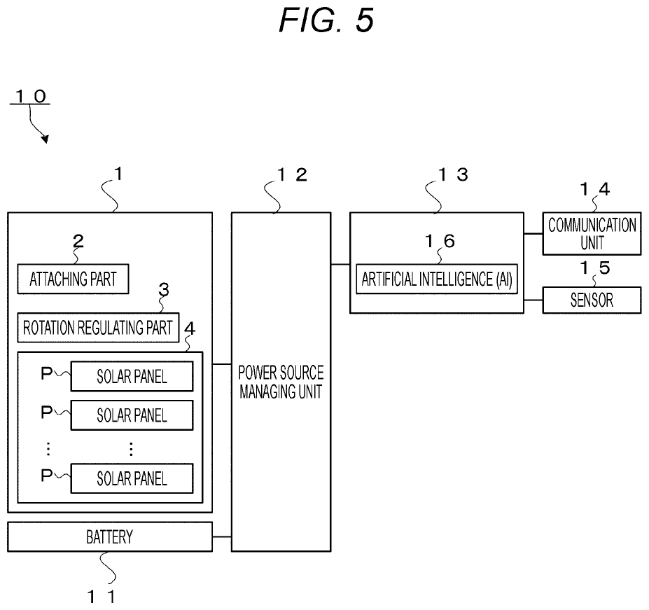

FIG. 5 is a block diagram showing a configuration example of an IoA apparatus to which the rotary apparatus 1 can be applied. The IoA apparatus 10 illustrated in FIG. 2 includes a rotary apparatus 1, a battery 11, a power source managing unit 12, a central processor 13, a communication unit 14, and a sensor 15.

The rotary apparatus 1 as a power generation part has the rotary part 4 to which the attaching part 2, the rotation regulating part 3, and the eight solar battery panels P are attached as described above and is configured to be operable to supply the power generated by the eight solar battery panels P to the power source managing unit 12.

The battery 11 stores the power generated by the rotary apparatus 1 via the power source managing unit 12 and functions to supply, as a power source, the power to the components constituted of the IoA apparatus 10 as needed. Specifically, the battery 11 is constituted of a secondary battery such as a button-type lithium-ion battery.

The power source managing unit 12 has a function to manage a power source of the IoA apparatus 10. Specifically, the power source managing unit 12 is connected to the rotary apparatus 1, the battery 11, and the central processor 13, manages power generation of the rotary apparatus 1 and discharge and charge of the battery 11, appropriately supplies the power to the central processor 13, the communication unit 14, and the sensor 15, and enables processing by the central processor 13.

The central processor 13 is constituted of, for example, a central processing unit (CPU) and has a function to perform various kinds of processes such as a sensing process. Specifically, the central processor 13 has a function to control artificial intelligence (AI) 16 and has a configuration in which action of the sheep is interpreted by the AI 16 by using sensing data supplied from the sensor 15 and a result of the interpretation can be wirelessly transmitted via the communication unit 14.

The communication unit 14 has a transmission function to transmit data to an information processing apparatus in a remote location (specifically, a cloud-side apparatus). For example, as a communication method by the communication unit 14, a Low Power Wide Area (LPWA) is cited. Note that the communication unit 14 may have a reception function as needed.

The sensor 15 has a function to output the sensing data. For example, the sensor 15 is controlled by the central processor 13 to periodically output the sensing data. Although the sensing data is not limited to specific data, as the sensing data, for example, measurements of an environment in which the sheep is present (specifically, sound, an image, a position, a temperature, a humidity, an atmospheric pressure, sunlight, rail-fall, wind, and the like) and measurements of states of the sheep (for example, a body temperature, a heart rate, a respiration rate, a blood pressure, a blood glucose level, electric activity of skin, and the like) are cited. The sensing data may be measurements of a plurality of kinds of sensing data.

Note that the battery 11, the power source managing unit 12, the central processor 13, the communication unit 14, and the sensor 15 may be provided integrally with the rotary apparatus 1 (for example, in an inside space provided for the rotary part 4) or one part or all of the battery 11, the power source managing unit 12, the central processor 13, the communication unit 14, and the sensor 15 may be provided as discrete bodies separated from the rotary apparatus 1.

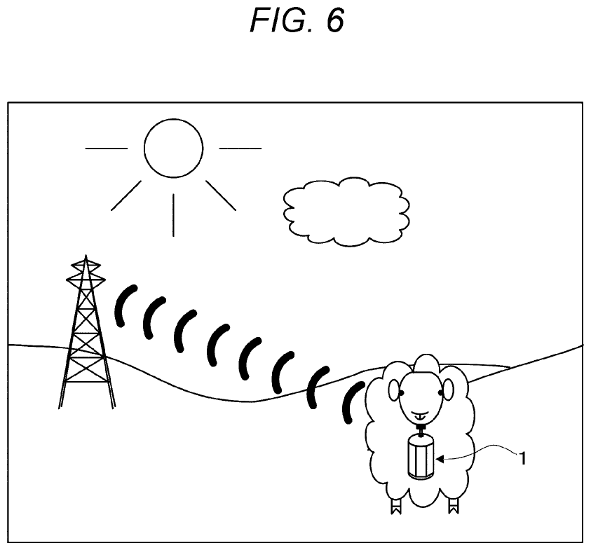

FIG. 6 is an explanatory diagram for explaining an operation example of the IoA apparatus 10. Specifically, FIG. 6 shows an image in which the IoA apparatus 10 is attached to a sheep under pasturing and is under operation. The sheep is pastured in sunny pasturage, and while the solar battery panels P are cleaned by the external force obtained from the action of the sheep, in the daytime, the power efficiently generated by the solar battery panels P which the rotary apparatus 1 has and have been already cleaned can be stored in the battery 11, thereby allowing a stable power source to be ensured (see FIG. 5). The stable power source is ensured; in addition thereto, the action of the sheep is obtained by the sensor 15; the action of the sheep is interpreted by the artificial intelligence 16 which operates on the central processor 13; a result of the interpretation can be wirelessly transmitted via the communication unit 14 (see FIG. 5); and the IoA apparatus 10 which uploads the action of the sheep to a cloud in a maintenance-free manner can be realized.

As described above, by using the rotary apparatus 1, while the power is energy-harvested by the solar battery panels P, energy required to clean the solar battery panels P can be energy-harvested form the external force (the motion of the sheep). Accordingly, without intervention of manpower and electric power, the solar battery panels P can be cleaned.

In addition, since the external force is converted to the energy required for cleaning without electric conversion, an energy conversion efficiency can be enhanced, as compared with an apparatus having a configuration in which the external force is converted to electricity.

Furthermore, by preventing adhesion of dirt to the solar battery panels P, stable solar battery power generation can be performed for a long period of time. Thus, for example, the battery 11 can be appropriately charged, and an IoA system in which a pastured animal is stably sensed for a long period of time and data is wirelessly transmitted can be realized.

### 2. Second Embodiment

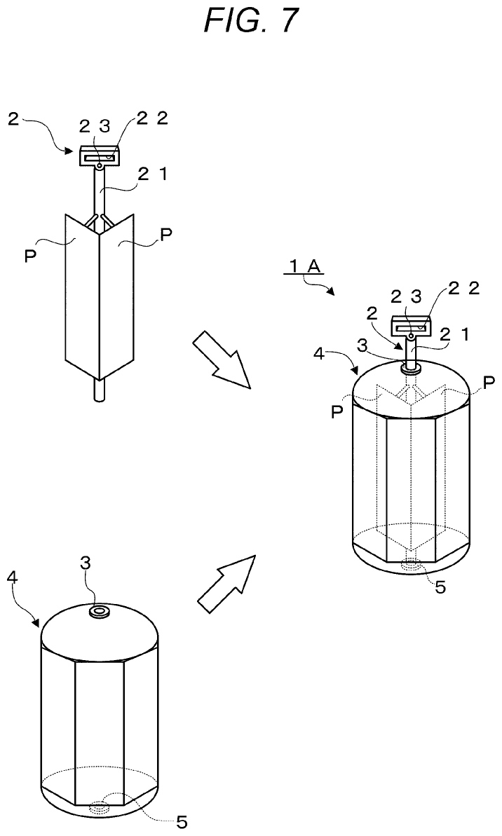

FIG. 7 shows views illustrating a configuration example of a rotary apparatus according to a second embodiment. In the rotary apparatus 1A illustrated in FIG. 7, an attachment place for solar battery panels P is different from that in the rotary apparatus 1 in the above-described first embodiment. Points other than the point described in the present embodiment are basically similar to those of the rotary apparatus 1 in the above-described first embodiment, and the description therefor will be omitted.

As illustrated in FIG. 7, the rotary apparatus 1A has the solar battery panels P in an internal space of the rotary part 4, instead of the external surface of the rotary part 4. Specifically, the solar battery panels P are fixed to a shaft part 21 of an attaching part 2. The rotary part 4 is attached to one end side of the shaft part 21 via a rotation regulating part 3, and the other end side is supported by a bearing part 5 which is constituted of a bearing or the like attached to the rotary part 4. Note that the rotary part 4 includes a transparent material, such as glass, which transmits light or of a material similar thereto and has a structure (structure having light transparency) which can supply light to the solar battery panels P. Specifically, the rotary part 4 has a housing part formed by an internal surface and is configured such that the solar battery panels P fixed to the shaft part 21 are housed in the housing part.

As described above, a body of a sheep as one example of a contact part has body pelage as a cleaning part. In addition, in the present embodiment, the rotary part 4 of the rotary apparatus 1A has light transparency and the solar battery panels P are housed therein. In other words, the rotary apparatus 1A has the above-described rotary part 4, rotation regulating part 3 which regulates rotation of the rotary part 4, and attaching part 2 which can attach the rotary part 4 to the body of the sheep in a state of being contactable with the body of the sheep and has a structure in which the rotary part 4 and the body of the sheep contact each other, thereby causing an external surface of the rotary part 4 as a light receiving part which receives light for the solar battery panels and transmits the light and the body pelage of the sheep, which cleans the external surface, to contact each other. Therefore, the rotary part 4 and the body of the sheep (the body pelage of the sheep in the present embodiment) slide with each other by the motion of the sheep described above, thereby cleaning the external surface of the rotary part 4. The light received by the external surface of the rotary part 4 is transmitted through the rotary part 4 and is supplied to the solar battery panels P. Accordingly, a daylighting state of the solar battery panels P can be favorably maintained.

In other words, by providing the structure in which the solar battery panels P are housed inside the rotary part 4 having the light transparency, adhesion of dirt to the solar battery panels P can be prevented. Even when the dirt has adhered to the external surface of the rotary part 4, as described above, since the external surface is cleaned by an external force, a state in which no dirt is present can be maintained, effect similar to that attained in the above-described first embodiment can be exhibited.

In addition, since the shaft part 21 of the attaching part 2 basically does not rotate, the solar battery panels P can be efficiently installed. In other words, it is not required to install the solar battery panels P in a place where light does not hit. Accordingly, for example, in a case where the solar battery panels P cannot be attached the whole outer peripheral surface of the rotary part 4 due to expensiveness of the solar battery panels P or the like, the present embodiment is useful. In addition, also in a case where daylighting surfaces of the solar battery panels P are deteriorated due to friction, the present embodiment is useful. In addition, since inside the rotary part 4, the solar battery panels P can be housed, it is made possible to protect the solar battery panels P.

### 3. Third Embodiment

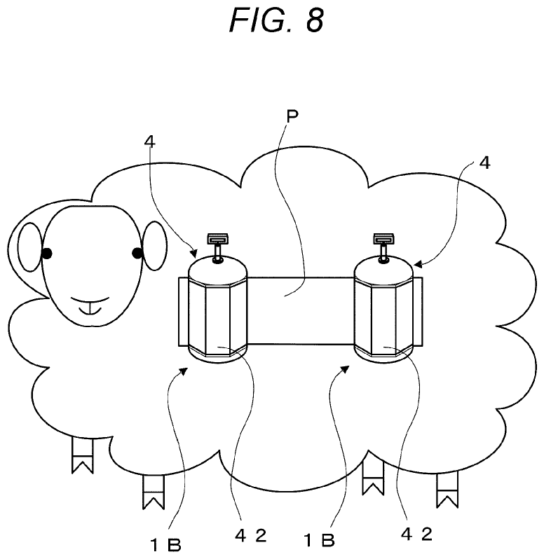

FIG. 8 is a diagram illustrating a configuration example of a rotary apparatus according to a third embodiment. The rotary apparatus 1B illustrated in FIG. 8 is different from the rotary apparatus 1 in the above-described first embodiment in that structures of solar battery panels P are discrete body structures. Points other than the point described in the present embodiment are basically similar to those of the rotary apparatus 1 in the above-described first embodiment, and the description therefor will be omitted.

As illustrated in FIG. 8, the rotary apparatus 1B does not have solar battery panels P on an external surface of a rotary part 4 and alternatively, has a cleaning body 42 having a function to clean daylighting surfaces of the solar battery panels P. For example, the cleaning body 42 can be configured by a cleaning brush, an unwoven fabric, a dirt adsorption mop, or the like. Specifically, the rotary part 4 of the rotary apparatus 1B has the cleaning body 42 on the whole external surface which constitutes a side surface. Note that the cleaning body 42 may be partially provided on the external surface which constitutes the side surface of the rotary part 4.

The solar battery panels P are attached to a body of a sheep (a trunk part in an illustrated example). Note that as illustrated in FIG. 8, the solar battery panels P in the present embodiment are not required to be portable. For example, the solar battery panels P can be attached to the sheep via a mounting fixture such as a belt (illustration is omitted). Note that the attachment place for the solar battery panels P is not limited to the trunk part and may be a neck, a breast, a back, buttocks, or the like.

The rotary apparatus 1B is attached in a state in which in a still state, light hits the solar battery panels P attached to the sheep and the sheep moves, and the daylighting surfaces of the solar battery panels P are cleaned. Note that although in the illustrated example, two rotary apparatuses 1B are attached to a left trunk part of the sheep and the two rotary apparatuses 1B have structures, in each of which the solar battery panels P are cleaned by a pendular motion, the present embodiment is not limited to the structures as mentioned above. For example, the number of rotary apparatuses 1B may be one or three or more. In addition, the rotary apparatus 1B may have a structure for performing reciprocating motion in which the body of the sheep slides forward and backward, instead of the pendular motion. In this case, a range which is cleaned by the rotary apparatuses 1B can be widened.

As described above, in the present embodiment, contact parts which the rotary part 4 contact are the solar battery panels P attached to the body of the sheep, and light receiving parts are the same solar battery panels P as the above-mentioned solar battery panels P. In addition, the rotary part 4 of each of the rotary apparatuses 1B has the cleaning body 42 as the cleaning part. In other words, each of the rotary apparatuses 1B has the above-described rotary part 4, a rotation regulating part 3 which regulates rotation of the rotary part 4, and an attaching part 2 which can attach the rotary part 4 to the body of the sheep in a state of being contactable with the body of the sheep and has a structure in which the rotary part 4 and the body of the sheep contact each other and the solar battery panels P as the light receiving parts which receive light for the solar battery panels and the cleaning body 42 which cleans the solar battery panels P and is attached to the external surface of the rotary part 4 contact each other. Therefore, the rotary part 4 (specifically, the cleaning body 42) and the solar battery panels P slide with each other by motion of the sheep and the solar battery panels P are cleaned, thereby favorably maintaining a daylighting state of the solar battery panels P.

In other words, by using the rotary apparatuses 1B, daylighting surfaces of the solar battery panels P which are discrete bodies separated from the rotary apparatuses 1B can be cleaned by an external force. For example, in a case where the rotary apparatuses 1B are attached to an animal, such as a rhinoceros and a hippopotamus, which does not have sufficient pelage to clean the daylighting surfaces of the solar battery panels P, as described above, it is also useful to make the solar battery panels P and the rotary apparatuses 1B the discrete body structures and clean the daylighting surfaces of the solar battery panels P by the rotary apparatuses 1B having the cleaning bodies 42 on the external surfaces of the rotary parts 4.

### 4. Fourth Embodiment

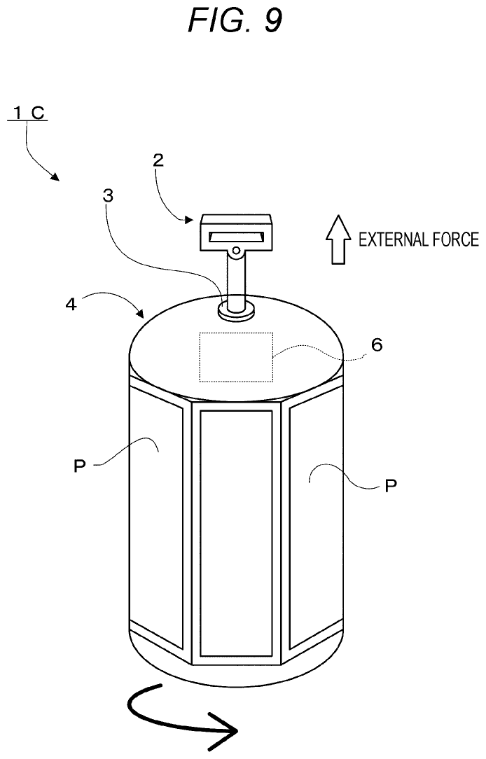

FIG. 9 is a diagram illustrating a configuration example of a rotary apparatus according to a fourth embodiment. The rotary apparatus 1C illustrated in FIG. 9 is different from the rotary apparatus 1 in the above-described first embodiment in that the rotary apparatus 1C has an energy conversion part 6. Points other than the point described in the present embodiment are basically similar to those of the rotary apparatus 1 in the above-described first embodiment, and the description therefor will be omitted.

The energy conversion part 6 has a function to convert an external force to rotation energy when the external force is exerted in a direction in which an attaching part 2 leaves away from a rotary part 4 (a direction indicated by an arrow in FIG. 9). Specifically, by providing the well-known mechanical structure, which converts linear motion to rotation motion between the attaching part 2 and the rotary part 4, the energy conversion part 6 converts the external force exerted on the attaching part 2 to the rotation energy which rotates the rotary part 4.

For example, when a sheep in a state in which the sheep is eating grass lifts up its neck, this external force can be obtained by inertia due to mass of the rotary part 4 of the rotary apparatus 1C and lifting-up energy exerted on the attaching part 2. The present embodiment is useful in a use case in which the above-mentioned external force can be easily obtained.

Since by using the rotary apparatus 1C, when the external force is exerted in the direction in which the attaching part 2 leaves away from the rotary part 4, the rotary part 4 can be rotated by the external force, even in a case a frictional force is not generated in a rotational direction of the rotary part 4, the rotary part 4 can be rotated. For example, even in a case where the sheep does not move around, when the sheep lifts up its neck, such as when the sheep eats feed, the rotary part 4 can be rotated.

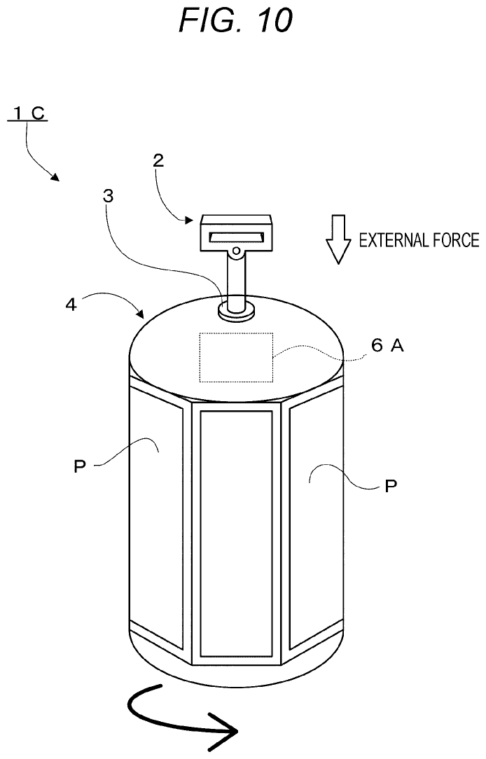

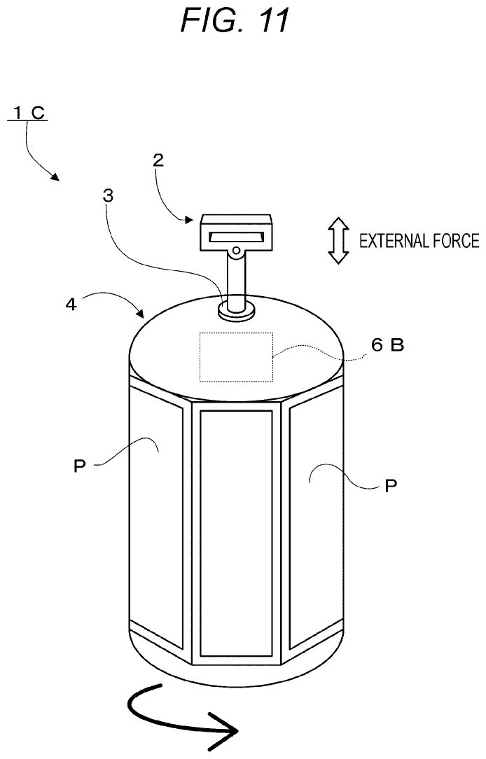

Note that the energy conversion part 6 is not limited to that illustrated in FIG. 9. FIGS. 10 and 11 are diagrams illustrating other configuration examples of the rotary apparatus 1C according to the fourth embodiment. The rotary apparatus 1C illustrated in FIG. 10 has an energy conversion part 6A, instead of the energy conversion part 6.

The energy conversion part 6A has a function to convert an external force to rotation energy when the external force is exerted in a direction in which an attaching part 2 approaches a rotary part 4 (a direction indicated by an arrow in FIG. 10). Specifically, by providing the above-described mechanical structure (a structure coping with an opposite external force direction), the energy conversion part 6A converts the external force exerted on the attaching part 2 to rotation energy which rotates the rotary part 4.

In this case, for example, when the sheep faces downward to eat grass, this external force can be obtained by inertia due to mass of the rotary part 4 of the rotary apparatus 1C and downward energy exerted on the attaching part 2 on a neck of the sheep. The present embodiment is useful in a use case in which the above-mentioned external force can be easily obtained.

Since by using this energy conversion part 6A, when the external force is exerted in the direction in which the attaching part 2 approaches the rotary part 4, the rotary part 4 can be rotated by the external force, even in a case where a frictional force is not generated in a rotational direction of the rotary part 4, the rotary part 4 can be rotated. For example, even in a case where the sheep does not move around, when the neck is lowered, such as when the sheep eats feed, the rotary part 4 can be rotated.

In addition, the rotary apparatus 1C illustrated in FIG. 11 has an energy conversion part 6B, instead of the energy conversion part 6. The energy conversion part 6B has a function to convert an external force to rotation energy when the external force is exerted in any of a direction in which an attaching part 2 leaves away from a rotary part 4 and a direction in which the attaching part 2 approaches the rotary part 4 (a direction indicated by an arrow in FIG. 11). Specifically, by providing the above-described mechanical structure (a structure coping with the external force in both of the directions), the energy conversion part 6B converts the external force exerted on the attaching part 2 to rotation energy which rotates the rotary part 4.

In other words, the energy conversion part 6B is a combination of the energy conversion part 6 and the energy conversion part 6A (having both of the functions). For example, action of the sheep of facing downward to eat the grass and action of the sheep of lifting up its head are often seen, and this external force can be obtained by such lifting-up and lowering of the head. The present embodiment is useful in a use case in which the above-mentioned external force can be easily obtained.

Since by using the energy conversion part 6B, when the external force is exerted in any of the direction in which the attaching part 2 leaves away from the rotary part 4 and the direction in which the attaching part 2 approaches the rotary part 4, the rotary part 4 can be rotated by the external force, even in a case where a frictional force is not generated in a rotational direction of the rotary part 4, the rotary part 4 can be rotated. For example, even in a case where the sheep does not move around, when the sheep raises or lowers its neck, such as when the sheep eats feed, the rotary part 4 can be rotated.

As described above, the rotary apparatus 1C in the present embodiment has a structure (the energy conversion part 6, the energy conversion part 6A, or the energy conversion part 6B) which converts the external force to the rotation energy which rotates the rotary part 4 when the external force is exerted in at least one of the direction in which the attaching part 2 leaves away from the rotary part 4 and the direction in which the attaching part 2 approaches the rotary part 4. Accordingly, effect similar to that exhibited by the rotary apparatus 1 in the first embodiment is exhibited, and even when the frictional force is not generated in the rotational direction of the rotary part 4 of the rotary part 4, effect that the rotary part 4 can be rotated can be obtained.

### 5. Fifth Embodiment

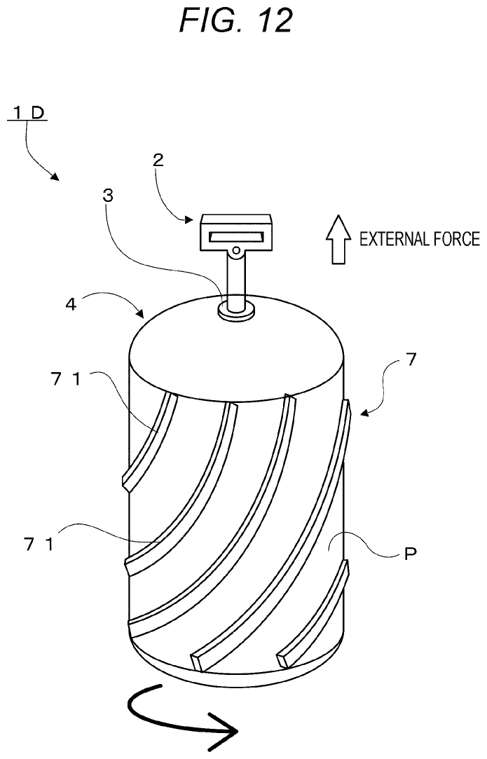

FIG. 12 is a diagram illustrating a configuration example of a rotary apparatus according to a fifth embodiment. The rotary apparatus 1D illustrated in FIG. 12 is different from the rotary apparatus 1 in the above-described first embodiment in that the rotary apparatus 1D has a rotation promoting part 7. Points other than the point described in the present embodiment are basically similar to those of the rotary apparatus 1 in the above-described first embodiment, and the description therefor will be omitted.

The rotation promoting part 7 has a function to promote rotation of a rotary part 4 when an external force is exerted in a direction in which an attaching part 2 leaves away from the rotary part 4 (goes upward) (a direction indicated by an arrow in FIG. 12). Specifically, as illustrated in FIG. 12, the rotation promoting part 7 is formed by providing screw-groove-shaped projection parts 71 on an external surface constituted of a side surface of the rotary part 4. It is preferable that the projection parts 71 are formed of a transparent material, such as glass, which transmits light or of a material similar thereto such that light hits daylighting surfaces of solar battery panels P. Note that a shape of each of the projection parts 71 is not limited to the above-mentioned shape and may be another shape as long as the projection parts 71 promote the rotation of the rotary part 4. In addition, the rotation promoting part 7 may be formed by providing recessed parts by depressed parts, instead of providing the projection parts 71 on the external surface constituted of the side surface of the rotary part 4. Note that although in an illustrated example, the rotary part 4 is of a cylindrical shape and the solar battery panels P are provided along the external surface constituted of the side surface thereof in a curved surface state, shapes of the rotary part 4 and the solar battery panels P are not limited thereto.

As described above, action of the sheep of facing downward to eat the grass and action of the sheep of lifting up its head are often seen. Accordingly, for example, the attaching part 2 is pulled upward while pelage of the sheep and the projection parts 71 of the rotary part 4 as illustrated in FIG. 12 contact each other when the sheep lifts up its head, thereby allowing daylighting surfaces of the solar battery panels P to be cleaned while the rotation of the rotary part 4 is promoted. The present embodiment is useful in a case where a frequency at which the rotary apparatus 1D is swung up and down is higher than a frequency at which the rotary apparatus 1D is swung from side to side.

As described above, since by using the rotary apparatus 1D, when the attaching part 2 is pulled upward, the rotation of the rotary part 4 is promoted by the rotation promoting part 7, even in a case where a frictional force generated in a rotational direction of the rotary part 4 is weak, the rotary part 4 can be rotated.

Note that the rotation promoting part 7 may have a function to promote the rotation of the rotary part 4 when the external force is exerted in a direction in which the attaching part 2 approaches the rotary part 4 (goes downward). In this case, by using the rotary apparatus 1D, the rotation of the rotary part 4 is promoted by the rotation promoting part 7 when the attaching part 2 is lowered, and even in a case where a frictional force generated on the external surface is weak, the rotary part 4 can be rotated.

As described above, the rotary apparatus 1D in the present embodiment has the rotation promoting part 7 which promotes the rotation of the rotary part 4 when the external force is exerted in the direction in which the attaching part 2 leaves away from the rotary part 4 or the direction in which the attaching part 2 approaches the rotary part 4. Accordingly, effect similar to that exhibited by the rotary apparatus 1 in the first embodiment is exhibited, and even in a case where the frictional force is not generated in the rotational direction of the rotary part 4, effect that the rotary part 4 can be rotated can be obtained.

### 6. Sixth Embodiment

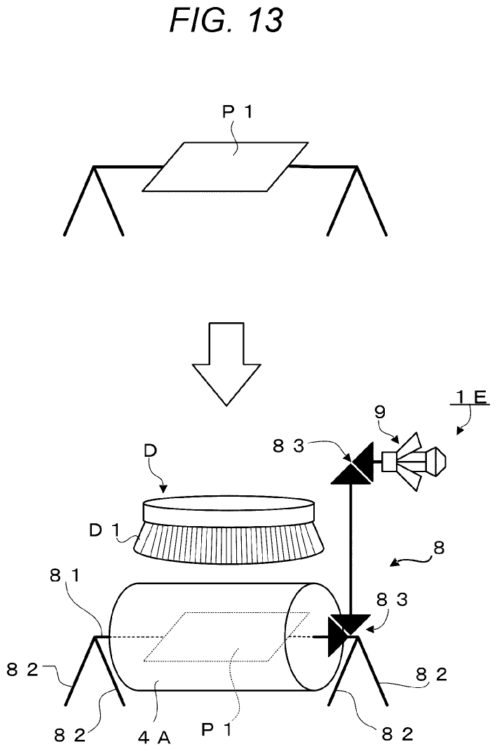

FIG. 13 is a diagram illustrating a configuration example of a rotary apparatus according to a sixth embodiment. The rotary apparatus 1E illustrated in FIG. 13 is a rotary apparatus which favorably maintains a daylighting state of an installation type solar battery panel P1 as illustrated on an upper stage.

As illustrated in FIG. 13, the rotary apparatus 1E has an installation part 8 as an attaching part, an external force conversion apparatus 9, and a rotary part 4A. The installation part 8 corresponds to the attaching part 2 of the rotary apparatus 1 in the above-described first embodiment and has a structure for attaching (installing) the rotary apparatus 1E to an attaching target. Note that as to this rotary apparatus 1E, an attaching target is an installation place for the installation type solar battery panel P1 such as the ground, a roof floor, and a roof.

Specifically, the installation part 8 has a rod-like shaft part 81 which supports the rotary part 4A, leg parts 82 which support both end sides of the shaft part 81, and rotation transmission parts 83 which transmit rotation. For example, each of the rotation transmission parts 83 is constituted of a bevel gear or the like, which changes a direction of a rotational axis. Note that a structure, the number, an installation place, and the like of the installation parts 8 are not limited to these.

The external force conversion apparatus 9 is constituted of a mechanical apparatus which converts an external force to rotation energy in one direction and has a function to convert the external force, specifically, wind power to the rotation energy and a function to regulate the rotational direction in one direction. Note that although the description as to a specific kind, a structure, and the like of the external force conversion apparatus 9 is omitted here, these are not limited to particular ones and the already-known technologies can be adopted.

The rotary part 4A is a member rotatable in a state in which the rotary apparatus 1E is installed by the installation part 8. For example, this rotary part 4A is formed of a transparent material, such as glass, which transmits light or of a material similar thereto and has a structure (a structure having light transparency) which can supply light to the solar battery panel P1. Specifically, the rotary part 4A is formed in a cylindrical shape whose opening part is closed, the shaft part 81 of the installation part 8 is located on a center line of a cylindrical body thereof, and the rotary part 4A is attached in such a way as to be rotatable with the shaft part 81 as a center. The rotation energy generated by the external force conversion apparatus 9 is transmitted via the installation part 8 to this rotary part 4A. The rotational direction of the rotary part 4A is regulated in one direction by the external force conversion apparatus 9. Note that the solar battery panel P1 is attached in such a way as not to rotate. Then, a contact part D contacts an external surface of the rotary part 4A. The contact part D has a cleaning body D1 and a fixing part (illustration is omitted) which fixes the cleaning body D1. Specifically, the cleaning body D1 is constituted of a cleaning brush, an unwoven fabric, a dirt adsorption mop, or the like.

As described above, in the present embodiment, the rotary part 4A of the rotary apparatus 1E contacts the contact part D. In addition, the rotary part 4A has the light transparency and houses the solar battery panel P1 therein. In other words, the rotary apparatus 1E has the above-described rotary part 4A, external force conversion apparatus 9 which regulates rotation of the rotary part 4A, and installation part 8 which can attach the rotary part 4A to the installation place for the solar battery panel P1 in a state of contacting the contact part D, and the rotary apparatus 1E has a structure in which by bringing the rotary part 4A and the contact part D in contact with each other, the external surface of the rotary part 4A as a light receiving part which receives light for the solar battery panel and the cleaning body D1 as a cleaning part contact each other. Therefore, as described above, the external surface of the rotary part 4A is cleaned by the rotation energy obtained by converting the wind power. The light received by the external surface of the rotary part 4A is transmitted through the rotary part 4A and is supplied to the solar battery panel P1. Accordingly, the daylighting state of the solar battery panel P1 can be favorably maintained.

In other words, the solar battery panel P1 is housed inside the rotary part 4A, thereby allowing dirt to be prevented from adhering to the solar battery panel P1. In addition, since even when the dirt has adhered to the external surface of the rotary part 4A, the rotary part 4A is rotated by the wind power and the dirt is cleaned by the cleaning body D1, a state in which the dirt is not present can be maintained, and effect similar to that exhibited in the above-described first embodiment can be exhibited. Accordingly, the technology of the present disclosure can be applied to the installation type solar battery panel P1, a mechanism for wiping off the dirt without using manpower and a power source can be realized. As described above, the present embodiment is useful also for the installation type solar battery panel P1.

As described above, by using the rotary apparatus 1E, adhesion of the dirt to the solar battery panel P1 and the rotary part 4A is prevented, stable solar battery power generation can be conducted for a long period of time, and the present embodiment serves as one means for reducing a maintenance frequency of, for example, a mega solar facility.

### 7. Seventh Embodiment

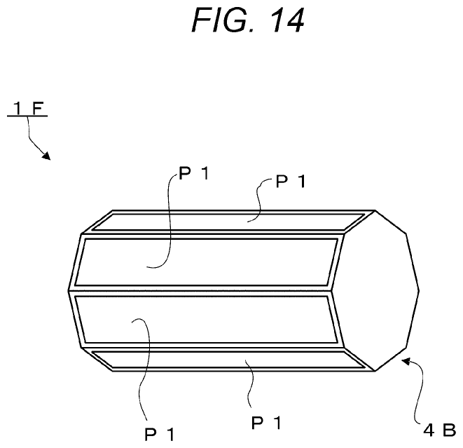

FIG. 14 is a diagram illustrating a configuration example of a rotary apparatus according to a seventh embodiment. The rotary apparatus 1F illustrated in FIG. 14 is different from the rotary apparatus 1E of the above-described sixth embodiment in that attachment places for the solar battery panels P1 are different from the attachment place for the solar battery panel P1 in the rotary apparatus 1E. Points other than the point described in the present embodiment are basically similar to those of the rotary apparatus 1E in the above-described sixth embodiment, and the description therefor will be omitted.

The rotary apparatus 1F has a rotary part 4B, instead of the above-described rotary part 4A. As with the rotary part 4 in the first embodiment, the rotary part 4B has an octagonal prism-shaped external surface, and respective solar battery panels P1 are attached onto eight external surfaces constituting a side surface thereof. The solar battery panels P1 may be attached onto one part of the eight external surfaces, instead of all of the eight external surfaces. Note that in FIG. 14, only the rotary part 4B is schematically illustrated and other structures are omitted.

As described above, in the present embodiment, the rotary part 4B of the rotary apparatus 1F contacts a contact part D (see FIG. 13). In addition, the rotary part 4B has the solar battery panels P1 on the external surfaces. In other words, the rotary apparatus 1F has the above-described rotary part 4B, an external force conversion apparatus 9 which regulates rotation of the rotary part 4B, and an installation part 8 which can attach the rotary part 4B to installation places for the solar battery panels P1 in a state of contacting the contact part D, and the rotary apparatus 1F has a structure in which by bringing the rotary part 4B and the contact part D in contact with each other, the solar battery panels P1 as light receiving parts which receive light for the solar battery panels and a cleaning body D1 as a cleaning part contact each other. Therefore, as described above, the solar battery panels P1 are cleaned by rotation energy obtained by converting wind power, and a daylighting state of the solar battery panels P1 can be favorably maintained.

In other words, by using this rotary apparatus 1F, daylighting surfaces of the solar battery panels P1 which are attached onto the external surface of the rotary part 4B can be cleaned by an external force. For example, the present embodiment is useful in a case where it is desired that a further large number of solar battery panels P1 be installed in a small lot of land. In addition, it has been known that a power generation efficiency of the solar battery panels P1 is reduced due to heat, solar battery panels P1 sequentially heated in a sunny place due to the rotation can be replaced with solar battery panels P1 cooled in a shaded place, and the present embodiment is useful also for improving the power generation efficiency.

<8. Modified Example>

Although hereinbefore, the preferred embodiments of the present disclosure are specifically described, contents of the present disclosure are not limited to the above-described embodiments and a variety of modifications can be made.

For example, although in the above-described first embodiment, as the attaching target of the rotary apparatus 1, an animal such as the sheep is illustrated as an example, the present disclosure is not limited thereto, and the attaching target may be a human being, a vehicle, a moving machine, and the like as long as the attaching target moves. The same is applied to the second to fifth embodiments.

In addition, for example, although in the above-described sixth embodiment, as the external force for rotating the rotary part 4A of the rotary apparatus 1E, the wind power is illustrated as an example, the present disclosure is not limited thereto, and the external force may be an external force utilizing hydraulic power or may be an external force utilizing thermal energy such as terrestrial heat. In addition, the external force may be an external force utilizing motion, such as a treading force, of a living creature such as a human being and an animal, may be an external force utilizing motion of a machine, or the like. The same is applies to the seventh embodiment.

In other words, in the technology of the present disclosure, a force generated in a daily life in a natural environment (specifically, a force other than electric power) can be used as the external force.

In addition, for example, although in the above-described first embodiment, the case where the rotary apparatus 1 is applied to the IoA apparatus 10 is described, an apparatus to which the technology of the present disclosure can be applied is not limited thereto. Specifically, the technology of the present disclosure can be applied to a variety of apparatuses, each of which uses the power by the solar battery panel P (for example, a terminal apparatus for watching over, a light, an accessory, a toy, and the like).

In addition, for example, the technologies described in the embodiments and the modified example in the present description may be appropriately combined within the realms of possibility.

The present disclosure can also adopt the following configurations:

(1)

A rotary apparatus including:

a rotary part which rotates by being imparted an external force;

a rotation regulating part which regulates rotation of the rotary part in one direction; and

an attaching part which allows the rotary part to be attached in a state of being contactable with a contact part, in which

by sliding the rotary part and the contact part with each other, a light receiving part which receives light for a solar battery panel is cleaned.

(2)

The rotary apparatus according to (1), in which

the contact part has a cleaning part.

(3)

The rotary apparatus according to (2), in which

the cleaning part is body pelage of an animal.

(4)

The rotary apparatus according to (2), in which

the light receiving part has a solar battery panel which is attached to an external surface of the rotary part.

(5)

The rotary apparatus according to (2), in which

the rotary part has light transparency and houses the solar battery panel inside the rotary part, and

the light receiving part is an external surface of the rotary part.

(6)

The rotary apparatus according to (1), in which

the rotary part has a cleaning part, and

the contact part and the light receiving part are same solar battery panels.

(7)

The rotary apparatus according to any one of (1) to (6), further including

an energy conversion part which converts a force to rotation energy which rotates the rotary part when the force is exerted in at least any one of a direction in which the attaching part leaves away from the rotary part and a direction in which the attaching part approaches the rotary part.

(8)

The rotary apparatus according to any one of (1) to (7), further including

a rotation promoting part which promotes the rotation of the rotary part when an external force is exerted in a direction in which the attaching part leaves away from the rotary part or a direction in which the attaching part approaches the rotary part.

(9)

The rotary apparatus according to any one of (1) to (8), in which

in accordance with motion of an attaching target, the external force is imparted.

(10)

The rotary apparatus according to (9), in which

the attaching target is a pastured live stock.

(11)

The rotary apparatus according to any one of (1) to (10), in which

the solar battery panel is a portable solar battery panel.

(12)

The rotary apparatus according to any one of (1) to (11), in which

the solar battery panel is an installation type solar battery panel.

(13)

A cleaning method including: attaching a rotary part which rotates by being imparted an external force in a state contactable with a contact part; regulating rotation of the rotary part in one direction by a rotation regulating part; and cleaning a light receiving part which receives light for a solar battery panel by sliding the rotary part and the contact part with each other.

### REFERENCE SIGNS LIST

1, 1A, 1B, 1C, 1D, 1E, 1F Rotary apparatus
2 Attaching part
3 Rotation regulating part
4, 4A, 4B Rotary part
6, 6A, 6B Energy conversion part
7 Rotation promoting part
8 Installation part
9 External force conversion apparatus
42, B1 Cleaning body
B Contact part
P, P1 Solar battery panel

1. A rotary apparatus comprising:
a rotary part which rotates by being imparted an external force;
a rotation regulating part which regulates rotation of the rotary part in one direction; and
an attaching part which allows the rotary part to be attached in a state of being contactable with a contact part, wherein
by sliding the rotary part and the contact part with each other, a light receiving part which receives light for a solar battery panel is cleaned.

2. The rotary apparatus according to claim 1, wherein
the contact part has a cleaning part.

3. The rotary apparatus according to claim 2, wherein
the cleaning part is body pelage of an animal.

4. The rotary apparatus according to claim 2, wherein
the light receiving part has a solar battery panel which is attached to an external surface of the rotary part.

5. The rotary apparatus according to claim 2, wherein
the rotary part has light transparency and houses the solar battery panel inside the rotary part, and
the light receiving part is an external surface of the rotary part.

6. The rotary apparatus according to claim 1, wherein
the rotary part has a cleaning part, and
the contact part and the light receiving part are same solar battery panels.

7. The rotary apparatus according to claim 1, further comprising
an energy conversion part which converts a force to rotation energy which rotates the rotary part when the force is exerted in at least any one of a direction in which the attaching part leaves away from the rotary part and a direction in which the attaching part approaches the rotary part.

8. The rotary apparatus according to claim 1, further comprising
a rotation promoting part which promotes the rotation of the rotary part when an external force is exerted in a direction in which the attaching part leaves away from the rotary part or a direction in which the attaching part approaches the rotary part.

9. The rotary apparatus according to claim 1, wherein
in accordance with motion of an attaching target, the external force is imparted.

10. The rotary apparatus according to claim 9, wherein
the attaching target is a pastured live stock.

11. The rotary apparatus according to claim 1, wherein
the solar battery panel is a portable solar battery panel.

12. The rotary apparatus according to claim 1, wherein
the solar battery panel is an installation type solar battery panel.

13. A cleaning method comprising: attaching a rotary part which rotates by being imparted an external force in a state of being contactable with a contact part; regulating rotation of the rotary part in one direction by a rotation regulating part; and cleaning a light receiving part which receives light for a solar battery panel by sliding the rotary part and the contact part with each other.
